(19) United States
(12) Patent Application Publication
(10) Pub. No.: US 2010/0284294 A1
(43) Pub. Date: Nov. 11, 2010

(54) COMMUNICATION BY RETURN PATHWAY FROM A TERMINAL TO A TRANSMITTER FOR REDUCING IN PARTICULAR INTERFERENCE BETWEEN BEAMS FROM THE TRANSMITTER

(75) Inventors: Thomas Salzer, Issy Les Moulineaux (FR); Marios Kountouris, Austin, TX (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/811,261

(22) PCT Filed: Dec. 12, 2008
(86) PCT No.: PCT/FR2008/052293

§ 371 Date: Jul. 27, 2010

(30) Foreign Application Priority Data
Jan. 3, 2008 (FR) 0850020

(51) Int. Cl. H04W 24/00; H04W 72/04

(52) U.S. Cl. 370/252; 370/329

(57) ABSTRACT

The invention relates to a communication by return pathway from a terminal to a transmitter for reducing in particular interference between beams from the transmitter. A telecommunication system comprises a transmitter designed to render simultaneously active a first number of beams, as resources for a plurality of user terminals. Within the sense of the invention, each terminal calculates, while taking account of interference noise, at least one second preferred number of beams to be rendered simultaneously active by the transmitter, and sends to the transmitter, through the return pathway, an indication of this second preferred number, among information about the quality of reception. The transmitter can then adjust the first number of beams to be rendered active, as a function of the returns from the terminals, for a next burst.

The present invention relates to a communication over a return pathway from a terminal to a transmitter associated with a telecommunications network, in order to inform this transmitter on the quality of reception of data by the terminal.

It relates in particular to a communication (or “metric”) which would make it possible to adapt the transmission mode for example in an SDMA (Space Division Multiple Access) system. Such a system is characterized by the use of multiple antennas (technique called “MIMO” for “Multiple Input Multiple Output”) at transmission in order to generate beams which can be allocated to different user terminals. Thus, a transmitter (for example a base station in a mobile phone network) can contain a plurality of antennas generating a set of beams capable of being allocated to one or more terminals. Thus, a transmitter comprising M antennas can generate a maximum of M beams simultaneously. However, in practice, as will be seen below, a number K of beams, less than or equal to M, is generated, in particular in order to avoid interference between beams on the same channel at a user terminal.

The use of multiple antennas in order to serve several users (SDMA system), using a set of beams, is covered in recent standards for mobile radio networks, such as for example the E-UTRAN standard described in particular in: 3GPP TS 36.212, Version 8.0.0—“Physical Channels and Modulation (Release 8)”.

The invention is therefore presented below in a pure SDMA system, but it can also be used in a hybrid system combining the SDMA technique with any other multiple-access technique. In fact, in order to serve a plurality of terminals (for example more than M terminals), it can in particular be provided to serve K terminals at a time t, then K further terminals at a time t+1, etc. In a variant, it can be provided to serve K terminals in a frequency band F, then K further terminals in a frequency band F+1, etc. Thus, the invention can be used in a hybrid system combining the SDMA technique with, in particular, TDMA (Time Division Multiple Access) if it is decided to allocate the resources by time slots, or also OFDM or FDMA (Frequency Division Multiple Access) if it is decided to allocate the resources by different frequency bands, or also CDMA (Code Division Multiple Access) or others, when a return pathway is used in order to refine the choice of transmission parameters.

The invention relates to allocation of the beams to users “on the downward path” where the configuration of the transmission mode (number of beams, modulation, encoding, orientation of the beams, etc.) is determined generally by using information carried by an upward path (from the terminals to the transmitter), this upward path being called “return pathway” (or “feedback”). However, this return pathway is very expensive in terms of bit rate. It is therefore preferable to find a compromise between the quality of the information obtained by this feedback and the quantity of information sent. In an SDMA system where the resource allocation choice depends on information on the quality of reception expected for a large number of user terminals and for a large number of beams, the quantity of information sent on the return pathway can rapidly become prohibitive. A reduction in this quantity would involve implementation of a less powerful resource allocation technique.

Thus the techniques of the state of the art involve reducing the quantity of information on the return pathway while allowing the use of an algorithm for allocating and configuring connections (called “link configuration”) which is as powerful as possible. The choice of the number of beams active simultaneously according to the state of the art is carried out generally at the level of the base station only, which has the drawback that the base station does not know the impact of the interference between beams on the quality of the link to the user terminal. Feedback methods exist for informing the base station of this impact of the interference, but this information is a posteriori data and in any case requires a quantity of feedback that is often prohibitive. But without additional feedback on the impact of the interference, the base station is generally obliged to transmit a fixed number of beams in parallel in order to allow a terminal to assess the impact of the interference and to make a reliable estimation of the quality of the link. However, such a fixed configuration of the number of beams is not optimum for certain user terminals, according to their channel state.

Thus reference is made to FIG. 1 showing an SDMA (Space Division Multiple Access) system. The multiple antennas at the transmitter (for example a base station BS) are used to generate separate beams F1, F2, F3 representing the resources capable of being allocated to different terminals T1, T2, T3, T4. The number of different beams which can be generated simultaneously is generally equal to the number of antennas that the base station contains, this number being denoted M hereinafter (with M=3 in the example in FIG. 1). In principle, the maximum number of terminals which can be served simultaneously is also M.

A group of M antennas can generate a multiplicity of sets of M different beams. The optimum choice of one of these sets depends on the relative position of the terminals which must be served simultaneously and the state of their radio channels.

A feature of an SDMA system is the fact that the orthogonality of the resources is not assured, which creates interference between the signals transmitted on different beams at the level of the receiver of a terminal. In order to limit this interference, it is recommended to make a choice of a group of beams (in transmission mode) which will be adapted to a choice of a group of terminals to be served simultaneously.

By way of example in order to illustrate this point, the base station BS in FIG. 1 has three antennas and could therefore simultaneously serve three of the four terminals present. If the set of beams created by the array of antennas of the base station is then compared with the state of the channels of the user terminals (these channels being defined here only by their position), it is possible to understand the compromise that must be reached. Firstly, the base station BS must choose between the user terminals T3 and T4 which are both covered by the beam F3 but cannot be served simultaneously. A possible choice would therefore be to serve the user terminal T1 with the beam F1, terminal T2 with beam F2, and terminal T3 with beam F3.

However, the user terminal T2 is situated between beams F2 and F3, which means that it receives both beams with a similar quality. As a result, signals transmitted with beams F2 and F3 arrive at the receiver of terminal T2 with similar power, which generates high interference. The quality of the signal, if the latter were transmitted on beam F2, is therefore not assured.

In the knowledge that a signal transmitted on the beam F2 also creates some interference at the level of user terminals T1 and T3, use of the beam F2 is not optimum in relation to the configurations of the terminals shown here by their respective positions. Thus, the best choice for the system would be to save the power required to serve the user T2 and on the other hand, to serve only users T1 and T3. Then, users T2 and T4 could be served with another set of beams, for example beams F2 and F3 oriented differently.

It will thus be understood from this example that the optimum number of active beams for a transmission, which is K=2 in the example in FIG. 1, is not necessarily the maximum number M of beams that the transmitter is capable of producing simultaneously (with M=3 in the example in FIG. 1), due to the interference likely to be generated by a maximum number M of beams that are active simultaneously.

However, the transmitter BS does not a priori know the exact state of the channels of the user terminals at the moment of transmission and more particularly the interference generated on such channels by the allocation of beams and the chosen transmission mode. It is therefore difficult for it to chose:
the transmission mode, i.e. the set of beams and the number K of beams active simultaneously, and
the allocation of beams to each user terminal.

The purpose of the present invention is to improve the situation.

It proposes to this end a method of telecommunication in a system including at least one transmitter arranged in order to activate simultaneously a first number of beams, as resources for a plurality of user terminals, in which the user terminals receive telecommunications data via said beams.

At least one of the terminals transmits to the transmitter, by return pathway, an indication of at least one second preferred number of beams to be activated simultaneously by the transmitter.

It will be noted that the second preferred number is specific to the terminal, in that it is the result for example of the calculation of the terminal alone, or it is for example determined by the terminal alone, on the basis of information pre-recorded therein. It is transmitted to the transmitter in order to be optionally taken into consideration by the latter in particular in order to set the number of beams to be activated simultaneously. However, this number of activated beams will not necessarily correspond to the number of beams preferred by a terminal.

This second preferred number is calculated by the terminal, preferably by taking account of an interference noise.

Thus this calculation will take account of the interference which can result from the simultaneous reception of several beams by the same terminal, for example by making an estimation of a signal to interference plus noise ratio. Moreover, in a particular embodiment, it will be sought to maximize an estimation of the global bit rate that the transmitter can supply to the set of terminals, said estimation of the global bit rate being a function of the above-mentioned signal to interference plus noise ratio. A terminal can then determine its preferred number of beams as being the number of beams maximizing this estimation of the global bit rate.

It is therefore proposed to require from the terminal an indication of its preferred transmission mode (typically of the number of beams in parallel tolerated). This indication from the terminal with respect to its preferred transmission mode can then define a specific metric, used on the return pathway from the terminal to the base station, in order to inform the base station of this preferred mode.

Thus, the invention proposes to rely on a terminal for the latter to determine its preferred transmission mode, which can be the subject of a definition of a new metric used on the return pathway in order to inform the transmitter. This metric can, for example, form part of a set of information return metrics (or “feedback” hereinafter) allowing the base station to operate with the purpose of optimizing the global bit rate served to the set of user terminals while providing a satisfactory quality of service for each user terminal. A typical set of metrics can be constituted by:
a index of the beam preferred by the terminal (an integer for example),
a value for the quality of reception in this beam,
an indicator of transmission mode (for example an integer or a binary number indicating the preferred number of beams, according to possible variant embodiments of the invention).

Nevertheless, the invention is not limited to the application of such metrics. It is possible to provide for example for the return of information on the transmission mode indicator a priori, at the base station, by setting the beam used for a given user or by determining this preferred beam by a means other than the return pathway (for example an estimation made by the base station on the upward path). It is therefore possible to provide for a metric in which one of the items of information carried by the other above metrics could be available to the base station immediately without needing feedback from the terminals.

Other characteristics and advantages of the invention will become apparent on examining the detailed description below and the attached drawings in which, apart from FIG. 1 showing the allocation of resources in an SDMA system described above:

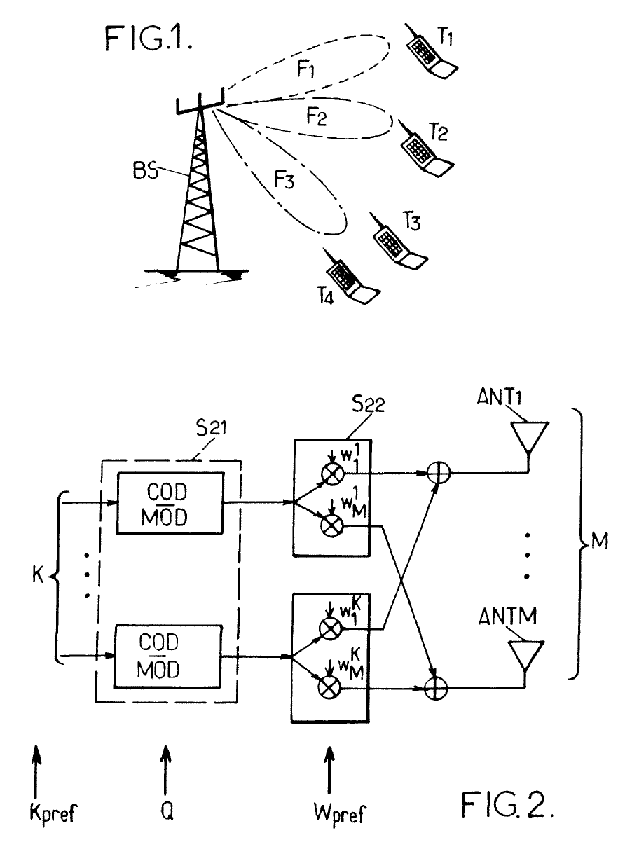

FIG. 2 shows diagrammatically the processing by the transmitter of the information communicated by the terminals on the return pathway,

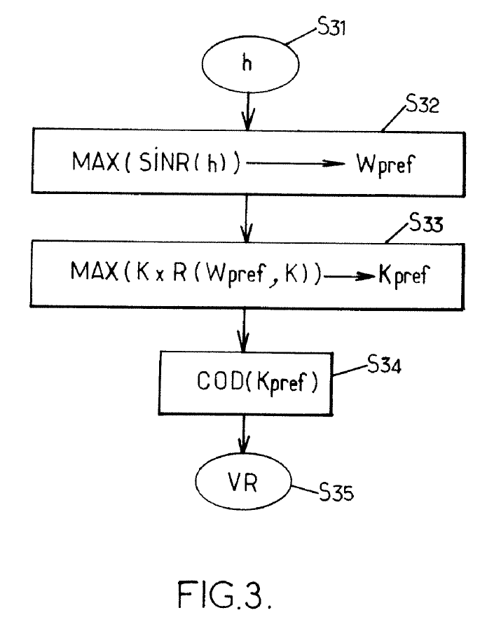

FIG. 3 shows diagrammatically the steps of a method within the meaning of the invention.

FIG. 2 shows an example of a functional block diagram implemented by a base station within the meaning of the invention. The base station is equipped with M antennas and can thus transmit a maximum of M information streams to the user terminals. The M antennas however generate K different beams simultaneously, with K≦M in order to avoid interference between beams. Here it is assumed that a different beam corresponds immediately to a served terminal. In a variant, it can be provided that several beams can be used by a single terminal, which can be carried out in practice for example as a function of the radio channel state and if the terminal, for its part, has a sufficient number of receiving antennas.

The set of beams used simultaneously for a transmission is denoted Ω={w₁, . . . , wₖ}. Although implementation of the invention is not, of course, limited to such an embodiment, it is thus assumed that: K≦M.

The set Ω is thus composed of K vectors of size M, denoted wₙ={w₁, . . . , w_{M}}. Each vector wₙ thus represents a different beam and has M complex coefficients (as components), these coefficients corresponding in practice to the weightings applied to each antenna branch in order to generate a beam wₙ.

In the example shown in FIG. 2, the base station receives from a terminal an item of information on the quality of the link Q in order to optimize the processing S21 of modulation and encoding for this terminal, as well as an item of information on a preferred beam w_{pref} in order to finally optimize the control S22 of the beams of antennas ANT1 . . . ANTM. Within the meaning of the invention, the base station moreover receives from the terminal a preferred number of beams K_{pref} in order to optimize the number K of beams to be transmitted.

More particularly, in order to generate the set of K beams, allocate them to the user terminals and carry out the “link adaptation” (which consists of choosing an optimum processing for modulation and encoding in step S21), the base station receives and interprets such information which is transmitted to it on the return pathway by a user terminal. By way of example, this can involve two types of information, as stated above:
a first item of information w_{pref} on the beam(s) preferred by the terminal, which can therefore depend on the position of the terminal with respect to the base station and/or its radio channel state,
a second item of information Q on the quality of the radio link that can be achieved in the beam(s) preferred by the terminal, this second item of information then making it possible to decide on the efficient allocation of a beam to a user and to carry out the link adaptation.

By way of example, the first item of information can be the index of a preferred vector from a set of vectors known by the terminal and the base station. This set can be defined by a dictionary (or “code-book”), that is common to the base station and the terminal. It can be provided as a variant for the base station to be able to choose the beams independently and transmit pilot signals on each beam in order to allow each terminal to identify them.

The size of the global set of beams that can be generated by the base station (taking account in particular of the different possible shapes of beams) is, in general terms, greater than or equal to the previously-defined number M and this set will hereinafter be denoted Ω′={w₁, . . . , w_{N}} with N≧M (and in particular with N=M in the above-mentioned case of a transmission of pilot signals in each beam as indicated above). It will be noted that the set of beams Ω actually transmitted can then be a subset of the set Ω′. It will thus be understood that the base station can freely orient or refine the K beams of the set Ω on the basis of the return of information received from the terminals, by making its choice from the set Ω′ of the N possibilities for beams.

The second item of information received can generally be based on an estimation, at the level of the terminal, of the “Signal to Interference plus Noise Ratio” (SINR). This estimation will be described below for a particular embodiment of the invention. The return of information, in itself, can be carried out for example according to the method disclosed in the document FR 2,893,468.

Within the meaning of the invention, it is proposed to combine a third type of information. This additional information informs the base station how many other bit streams (beams) the user terminal can tolerate in parallel with its current information stream. This information is advantageously quantified and its quantification is based on an estimation of the impact of the interference of the other beams on the quality of its current radio link. The value allocated as feedback in respect of this third item of information can be an integer or also be a single bit, according to variant embodiments described below.

In the following, it is assumed that each terminal explicitly knows the vectors of the set Ω′. The base station can for example transmit a pilot signal on each antenna allowing the terminal to estimate a complex coefficient hₘ representing the effect of the mobile radio channel between each antenna of the base station and the receiving antenna of the terminal. The radio channel between the base station and the terminal can thus be represented by a vector h={h₁, . . . , hₘ, . . . , h_{M}}.

As previously stated, the terminal can, in a variant, have several receiving antennas. Moreover, in a variant or in addition, the radio channel can be described by several complex coefficients at once, such as for example in the case of a selective frequency channel. In these variants, the channel is then described by a matrix (rather than by a single vector h) and the following expressions, given in the embodiment where a single vector h is allocated to a channel, can be suitably adapted. It will thus be understood that the invention is in no way limited to the allocation of a single vector to a channel.

Starting from the estimation of the channel of vector h and from the knowledge of the set of beams Ω′, the terminal can estimate the quality of its radio link in each of the beams assuming a transmission mode using a set Ω which is a subset of the set Ω′. Here, it is also assumed that the same power is allocated to all the beams. However, it can be provided to adapt the following expression to the case of a variant according to which the power allocation is not even.

According to the above-mentioned assumption, the signal to interference plus noise ratio (SINR), for a given beam wₙ can be written as follows:

$$SINR ( {w}_{n} , Ω ) = \frac{{\vert h \cdot {w}_{n} \vert}^{2}}{{\sum }_{Ω , i \neq n} {\vert h \cdot {w}_{i} \vert}^{2} + K {σ}^{2}} , n = 1 , … , N ,$$

where σ² represents the inverse of the signal-to-noise ratio (therefore the ratio between a receive noise and the power of the useful signal received by the terminal) and K the cardinal of the set Ω. Moreover, the notation h·wᵢ denotes the scalar product between the vector column h and the vector column wᵢ, so therefore h·wᵢ=h^{T}wᵢ.

It should be noted that, according to the definition of this metric, the terminal must make an assumption on the set Ω which will actually be chosen by the base station, the set Ω being therefore unknown to the terminal at the time when it makes an estimation of its quality of reception. As a result, the terminal cannot accurately calculate the interference portion (first term of the denominator).

However the possibility is demonstrated of establishing an estimation of the SINR ratio in a given beam wₙ with only the size K of the set Ω, the vector h and the global set Ω′ being known. To this end, reference can usefully be made to the document: “Efficient Metrics for Scheduling in MIMO Broadcast Channels with Limited Feedback”, M. Kountouris, R. of Francisco, D. Gesbert, D. Slock, T. Salzer, in Proceedings IEEE ICASSP, Hawaii, USA (April 2007).

An estimation can thus be chosen here in the form:

$$SINR ( {w}_{k} , K ) = \frac{{\vert h \cdot {w}_{k} \vert}^{2}}{C ( K , M , {σ}^{2} ) {\vert h \vert}^{2} {sin}^{2} θ + K {σ}^{2}} , k = 1 , … , K , \\ with θ = arccos \frac{h \cdot {w}_{k}}{{\vert h \cdot {w}_{k} \vert}^{2}} \qquad ( 1 )$$

This estimation is adequate on the assumption that the base station chooses a set Ω of orthogonal (or approximately orthogonal) vectors. This precaution is in any case desirable for reducing the interference between the beams transmitted simultaneously. The algorithm for selecting the beams of the base station therefore generally seeks to achieve such a configuration.

The function C(K,M, σ²) in the expression (1) above serves to estimate the impact of the interference with the other beams, advantageously having as the single assumption the number K of beams transmitted simultaneously. It is generally a non-linear and configurable function. It can be optimized according to the information available to the terminal, for example on the mode of adaptation and selection of the beams at the base station.

It is therefore possible for the terminal to choose a preferred beam from all the vectors of the set Ω′, represented by the vector w_{pref} given by an expression of the type: w_{pref}=argmax_{Ω′}|h·wₙ| (i.e. the vector wₙ of the global set Ω′ which has the largest scalar product in absolute value with the channel vector h). In other words, the preferred vector w_{pref} is therefore that which, advantageously, maximizes the projection on the channel vector h.

The index k of this vector (with wₖ=w_{pref}) in the global set Ω′ therefore represents one of the elements of the feedback to the base station. It should be noted that the terminal could also determine several beams with an order of preference and inform the base station of them according to a succession of values given in this order of preference.

During a second time, the terminal determines its preferred transmission mode. It is assumed here that the simultaneously-generated K beams are likely to create more or less significant interference with the beam served to a given user. As it is desired to minimize the interference for all of the users served (as previously mentioned with reference to FIG. 1), the number K will therefore be defined as being the optimum number of beams tolerated in parallel for each user.

Of course, a terminal will prefer to be served without interference from the other beams served simultaneously with its own. In this case (an ideal case where it will be assumed simply that K=1 for calculation of the SINR ratio), its SINR ratio can be written simply as follows:

$$SINR ( {w}_{pref} , 1 ) = \frac{{\vert h \cdot {w}_{k} \vert}^{2}}{{σ}^{2}}$$

Starting from this value for the SINR ratio, the terminal can estimate the bit rate that the base station is capable of transmitting to it in this configuration, this bit rate being denoted R(w_{pref},1). Generally, the terminal has for this purpose a look-up table allowing it to associate a bit rate with the SINR ratio. It can also, by approximation based on the Shannon limit, calculate the bit rate as follows:

R(w_{pref},1)=G log(1+SINR(w_{pref},1)),

where G is a constant of the system which depends in particular on the frequency band available and other parameters known by the terminal. This then is the maximum bit rate which can be supplied to this terminal if it is chosen by the base station.

However, the terminal can estimate its bit rate for the transmission of K beams in parallel in the same manner, with:

$$R ( {w}_{pref} , K ) = G log ( 1 + SINR ( {w}_{pref} , K ) )$$

$$with SINR ( {w}_{k} , K ) = \frac{{\vert h \cdot {w}_{k} \vert}^{2}}{C ( K , M , {σ}^{2} ) {\vert h \vert}^{2} {sin}^{2} θ + K {σ}^{2}} , \\ where {w}_{k} = {w}_{pref} and θ = arccos \frac{h \cdot {w}_{k}}{{\vert h \cdot {w}_{k} \vert}^{2}}$$

For the base station, it is preferable to serve several users simultaneously in order to maximize the global bit rate of the system. But the fact of serving an additional user terminal increases the interference and therefore reduces the bit rate per user. Usually, the base station cannot estimate a priori the impact of this interference created on the quality of the user links as it only knows their preferred beam w_{pref} but not their channel vector h.

An embodiment of the invention thus proposes to calculate the optimum configuration at the level of the terminal, using an approximation of the system bit rate. To this end, an approximation of a homogenous network is created, where each user is served with the same bit rate. The total bit rate thus represents simply the bit rate per user multiplied by the number K. This assumption is used only for calculating the optimum transmission mode but in no way limits the scope of application of the invention.

The terminal can then find its optimum configuration K_{pref} as follows:

$${K}_{pref} = {arg max}_{K = 1 , 2 , … , M} ( ( K \times R ( {w}_{pref} , K ) ) \qquad ( 2 )$$

This number will then be transmitted on the return pathway and will allow the base station to serve the user terminal in its preferred mode, which thus maximizes the bit rate while taking account of the global system, also including the other terminals.

In practice, it will often be useful not to indicate the number K_{pref}, in itself, but simply to indicate in binary mode if the terminal can or cannot tolerate other users in parallel with it. The terminal can therefore choose between a configuration K=1 and K=M and will indicate its preference by a single feedback bit.

It should be noted that, in the case where K=M, the function C(K,M,σ²) becomes trivial and the equation (1) is written:

$$SINR ( {w}_{k} , K ) = \frac{{\vert h \cdot {w}_{k} \vert}^{2}}{{\vert h \vert}^{2} {sin}^{2} θ + K {σ}^{2}} , k = 1 , … , K , \\ where θ = arccos \frac{h \cdot {w}_{k}}{{\vert h \cdot {w}_{k} \vert}^{2}}$$

FIG. 3 shows diagrammatically the main steps of the above method in an embodiment.

As previously indicated, the transmitter BS transmits to the terminal pilot signals allowing the terminal to estimate the coefficients h₁, . . . , h_{M} each representing a radio channel between an antenna of the transmitter and this terminal (or the antenna of the terminal). Based on these coefficients h₁, . . . , h_{M}, the terminal is capable of constituting in step S31 the vector h representing the global channel between the transmitter and the terminal. The beam preferred by this terminal is determined as a function of the vector h representing the global channel. It is recalled that the preferred beam is represented by a beam vector w_{pref} having, from the global set of possible beams Ω′, the greatest scalar product, in absolute value, with the vector h representing the global channel. In fact, according to the equation (1) given previously, this preferred beam represented by the vector W_{pref} maximizes, from the set of possible beams Ω′, the signal to interference plus noise ratio, estimated as a function of the channel vector h in step S32 in FIG. 3 and denoted SINR(h) in this FIG. 3. Seeking the maximum of the SINR(h) ratio, in the knowledge of the channel vector h, gives, after step S32 in FIG. 3, the vector of the preferred beam w_{pref}.

In generic terms, it will thus be understood that the terminal determines the preferred beam w_{pref} which maximizes, from a possible set of beams Ω′, an estimation of the signal to interference plus noise ratio SINR(w_{pref}, K). In particular, the beam preferred by the terminal w_{pref} is determined as a function of a global channel (of vector h) between the beams originating from the transmitter and this terminal, the global channel h being estimated from information transmitted by the transmitter to the terminal on coefficient values h₁, . . . , h_{M} each representing a channel between a beam originating from the transmitter and the terminal.

In the following step S33, the terminal derives, on the basis of equation (2) given previously, the preferred number of beams K_{pref} defined, according to said equation (2), as being the number of beams to activate in order to maximize the global bit rate, denoted K×R(w_{pref}, K), that the transmitter is capable of transmitting to the set of terminals. It is recalled that said global bit rate K×R(w_{pref}, K) is estimated as a function of the signal to interference plus noise ratio SINR(w_{pref},K).

It is also recalled that the signal to interference plus noise SINR(w_{pref}, K) is estimated by calculating an inverse variation function C(K,M,σ²), of the ratio SINR(w_{pref}, K), and dependent at least:
on the number of active beams K,
on a maximum number of beams M that the transmitter can activate simultaneously and which is generally equal to the number of antennas at the transmitter,
and on the ratio σ² between a received noise and the power of the useful signal received by the terminal, this noise and this power being able to be measured by the terminal.

Once the value K_{pref} is determined, the latter can for example be encoded, in step S34, in a single bit signifying that the terminal:
can tolerate only a single active beam, or
can tolerate a maximum number M of active beams.

In the following step S35, the value of the preferred number K_{pref}, thus encoded in one bit in the example described, is transmitted to the transmitter by the return pathway, with optionally an indication of the preferred beam represented by the vector w_{pref} and a value Q representing the quality of the radio link.

It will be noted that the steps shown in FIG. 3 are implemented by a single communicating entity, namely the user terminal. To this end, the present invention also relates to such a terminal comprising means for implementing the above method (for example a storage and/or a working memory, as well as a processor). The present invention also relates to a software program intended to be executed by such a processor.

However, the invention is of course not limited to the embodiment shown in FIG. 3. Moreover, for its part, the transmitter BS can adjust the number K of beams activated at least as a function of the indications of preferred numbers of beams K_{pref}, communicated by the user terminals. By way of a purely illustrative example, it is possible for a base station not to immediately serve a terminal (in particular in the embodiment where the preferred number K_{pref} is encoded in a single bit) indicating that it will not tolerate transmission of an excessive number of beams. This terminal can be served in a later burst, for example in a TDMA transmission mode, combined with an SDMA mode.

To this end, the present invention also relates to such a transmitter BS, then comprising means (for example also a storage and/or a working memory, as well as a processor) for adjusting the number K of activated beams at least as a function of the indications by the terminals of their preferred number of beams K_{pref}. The present invention also relates to a software program intended to be executed by such a processor.

The present invention also relates to a telecommunications system including at least one terminal within the meaning of the invention and a transmitter within the meaning of the invention. In an advantageous embodiment, such a system can be a space division multiple access or “SDMA” system.

The present invention also relates to the metric itself, making it possible to transmit to the base station the indication of the preferred number of beams K_{pref}. To this end, it then also relates to a signal transmitted by return pathway from a terminal to a transmitter comprising the information on the quality of reception of the telecommunications data, and in particular the preferred number of beams K_{pref}.

Thus, it is proposed to arrange for a user terminal to indicate its preferred transmission mode. In particular, the terminal transmits to the transmitter on the return pathway an indication of the number K_{pref}, that it prefers, of beams to be activated simultaneously by the transmitter. An associated feedback metric is then proposed. Implementation of the invention has in particular the following advantages:
the choice of the transmission mode is made at the terminal and does not require additional feedback in order to inform the transmitter of the impact of the interference between beams on the quality of the link,
the only knowledge required at the terminal is the global set of beams that the base station can generate,
no knowledge of the channels of the other user terminals and of the allocation decisions is required,
the feedback metric for the choice of mode is not very complex. It can involve an integer or simply a single bit.

1. A method of telecommunication in a system including at least one transmitter arranged in order to activate simultaneously a first number of beams, as resources for a plurality of user terminals, in which the user terminals receive telecommunications data via said beams,
wherein at least one of the terminals transmits to the transmitter, by return pathway, an indication of at least one second preferred number of beams to be activated simultaneously by the transmitter.

2. The method according to claim 1, wherein said second preferred number is calculated by said terminal while taking account of an interference noise.

3. The method according to claim 1, wherein said terminal:
estimates a global bit rate that the transmitter is capable of transmitting to the set of terminals,
and determines said second preferred number of beams as being the number of beams to be activated in order to maximize the estimation of said global bit rate.

4. The method according to claim 3, wherein said terminal estimates said global bit rate to be maximized as a function of a signal to interference plus noise ratio.

5. The method according to claim 4, wherein the signal to interference plus noise ratio is estimated by calculating an inverse variation function, of said ratio, and dependent at least on:
the number of active beams,
a maximum number of beams that the transmitter can activate simultaneously,
and a ratio between a receive noise and the power of the useful signal received by the terminal, measured by the terminal.

6. The method according to claim 1, wherein said indication of the second preferred number, transmitted to the transmitter by the return pathway, is encoded in a single bit signifying that a terminal:
can tolerate only a single active beam, or
can tolerate a maximum number of active beams.

7. A method of telecommunication in a system including at least one transmitter arranged in order to activate simultaneously a first number of beams, as resources for a plurality of user terminals, wherein the transmitter transmits telecommunications data to the user terminals, via said beams, wherein the transmitter adjusts said first number of activated beams at least as a function of an indication of a second preferred number of beams to be activated simultaneously, transmitted by at least one of said terminals on said return pathway.

8. A terminal intended for a telecommunications system comprising at least one transmitter arranged in order to activate simultaneously a first number of beams, as resources for a plurality of user terminals, comprising means for implementing the method according to claim 1.

9. A computer program comprising instructions for implementing the method according to claim 1 when said program is executed by a processor.

10. A transmitter intended for a telecommunications system, wherein said transmitter is arranged in order to activate simultaneously a first number of beams, as resources for a plurality of user terminals,
comprising means for implementing the method according to claim 7.

11. A computer program comprising instructions for implementing the method according to claim 7 when said program is executed by a processor.

12. A telecommunications system comprising at least one terminal according to claim 8 and at least one transmitter intended for a telecommunications system, wherein said transmitter is arranged in order to activate simultaneously a first number of beams, as resources for a plurality of user terminals, comprising means for implementing the method of telecommunication in a system including at least one transmitter arranged in order to activate simultaneously a first number of beams, as resources for a plurality of user terminals, wherein the transmitter transmits telecommunications data to the user terminals, via said beams, wherein the transmitter adjusts said first number of activated beams at least as a function of an indication of a second preferred number of beams to be activated simultaneously, transmitted by at least one of said terminals on said return pathway.

13. A signal transmitted by return pathway by at least one terminal to a transmitter in a telecommunications system, wherein the transmitter is arranged in order to activate simultaneously a first number of beams, as resources for a plurality of user terminals, the transmitter transmitting telecommunications data to the user terminals, by said beams, the signal comprising an indication of a second preferred number of beams to be activated simultaneously by the transmitter.
